(19) United States
(12) Patent Application Publication
(10) Pub. No.: US 2021/0192608 A1
(43) Pub. Date: Jun. 24, 2021

(54) Automated System for Car Access in Retail Environment

(71) Applicant: Capital One Services, LLC, McLean, VA (US)

(72) Inventor: Varshada Buchake, Frisco, TX (US)

(21) Appl. No.: 16/720,832

(22) Filed: Dec. 19, 2019

(51) Int. Cl. G06Q 30/06; G06Q 10/08; G08G 1/00; G07C 9/00; H04L 9/08; H04W 4/021

(52) U.S. Cl. CPC G06Q 30/0645; G06Q 10/087; G08G 1/205; G07C 2009/00396; H04L 9/0819; H04W 4/022; G07C 9/00309

(57) ABSTRACT

A computing device may receive customer information including at least identity information; determine a first set of vehicles for which the customer has been pre-qualified to finance, receive dealership information comprising an inventory of the respective vehicle dealership, wherein a first vehicle dealership has a corresponding inventory, determine that the first vehicle dealership is within a geographic threshold of the customer; validate a user device of the customer to establish a validated user device; and pre-provision the validated user device with a digital master key to create a provisioned user device configured to provide the user device with access rights to each vehicle within the corresponding inventory of the first vehicle dealership.

### FIELD OF USE

Aspects of the disclosure relate generally to electronic devices. More specifically, aspects of the disclosure may provide for systems and methods for unlocking vehicles with limited human interaction.

### BACKGROUND

Potential customers that are shopping for a vehicle are typically required to work directly with an auto dealership employee to get access to a vehicle located on the parking lots or other locations of automobile dealers. To get access to a vehicle to browse its interior, a potential customer has to locate an auto dealership employee and ensure that they are available to assist the customer. Often times the potential customer is required to provide personal information to the auto dealership employee before they are allowed to browse the interior of a vehicle. Additionally, in order to browse multiple vehicles, the potential customer may have to spend an extended time with the auto dealership employee, answering questions while they are attempting to review the interiors of the vehicles.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects discussed herein may provide a computer-implemented method for facilitating access to the interior of one or more vehicles in a retail environment. The method may utilize modern technology to provide a pre-qualified user with access to a vehicle without the need for an in-person salesman, while managing inventory and vehicle access.

In accordance with one aspect, a method may include receiving, from a user device, customer information corresponding to a customer, the customer information including at least identity information; determining, based on the customer information, a first set of vehicles for which the customer has been pre-qualified to finance, the first set of vehicles comprising at least one vehicle of a first model. The method may also include receiving dealership information from a plurality of vehicle dealerships, the dealership information comprising an inventory of the respective vehicle dealership, wherein a first vehicle dealership has a corresponding inventory comprising a plurality of vehicles including a first vehicle matching the first model; and determining that the first vehicle dealership is within a geographic threshold of the customer. The method may further include validating, with at least a portion of the identity information, a user device of the customer to establish a validated user device; and pre-provisioning the validated user device with a digital master key to create a provisioned user device configured to provide the user device with access rights to each vehicle within the corresponding inventory of the first vehicle dealership.

Corresponding apparatus, systems, and computer-readable media are also within the scope of the disclosure. For example, in accordance with other aspects, computing devices may include at least one processor with a non-transitory computer-readable medium comprising computer-executable instructions that when executed by the at least one processor, cause the computing device to execute steps such as those described above.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example environment in accordance with one or more illustrative aspects discussed herein;

FIG. 3 depicts an example network in accordance with one or more illustrative aspects discussed herein;

FIG. 4 depicts an alternative example environment in accordance with one or more illustrative aspects discussed herein;

FIG. 5 depicts a flow diagram of an example method for facilitating a user unlocking and browsing a vehicle with limited human interaction, in accordance with one or more illustrative aspects discussed herein;

FIG. 6 depicts a flow diagram of another example method for facilitating a user unlocking and browsing a vehicle with limited human interaction, in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to systems, methods, techniques, apparatuses, and non-transitory computer readable media for accessing vehicles with minimal human interaction. For example, a customer may be pre-qualified to finance a first set of vehicles. A first vehicle dealership within a geographic threshold of the customer may have an inventory that includes a vehicle for which the customer is pre-qualified. A user device of the customer may be validated and pre-provisioned with a digital master key to create a provisioned user device to provide the user device with access rights to each vehicle within the inventory of the first vehicle dealership. As discussed further herein, this combination of features may allow a user to open and browse an interior of one or more vehicles.

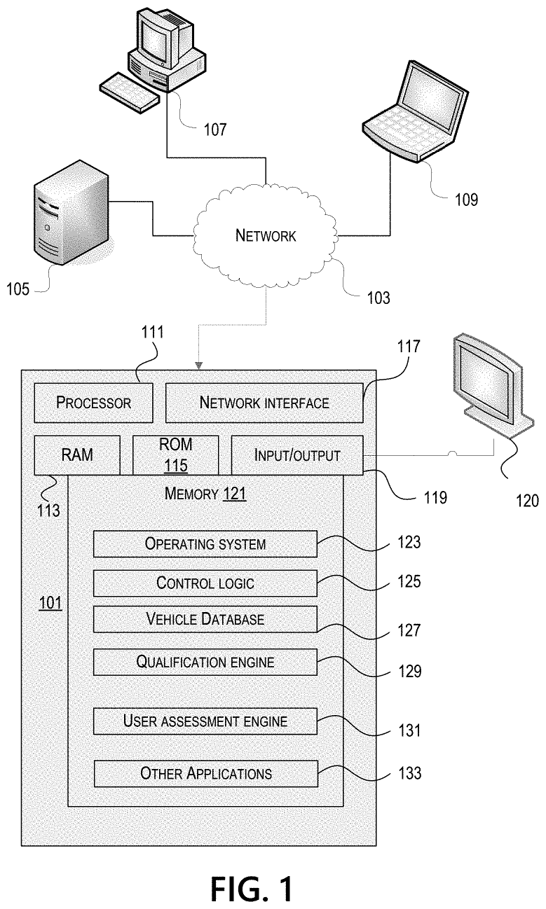

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associating smart key storage devices with vehicle keys, tracking the status of vehicle keys based on sensor data received from the smart key storage devices, generating vehicle access for a user (e.g., for a test drive), tracking vehicle locations, calculating directions to/from a vehicle, and other functions. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein. Furthermore, memory 121 may store various databases and applications depending on the particular use, for example, vehicle database 127, qualification engine 129, user assessment engine 131, and other applications 133 may be stored in a memory of a computing device used at a server system that will be described further below. Control logic 125 may be incorporated in and/or may comprise a linking engine that updates, receives, and/or associates various information stored in the memory 121 (e.g., smart key storage device identifiers, vehicle and vehicle key identifiers, locking information, statuses, location information, directional information, etc.). In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to an illustrative environment and network for unlocking and browsing vehicles with minimal human interaction.

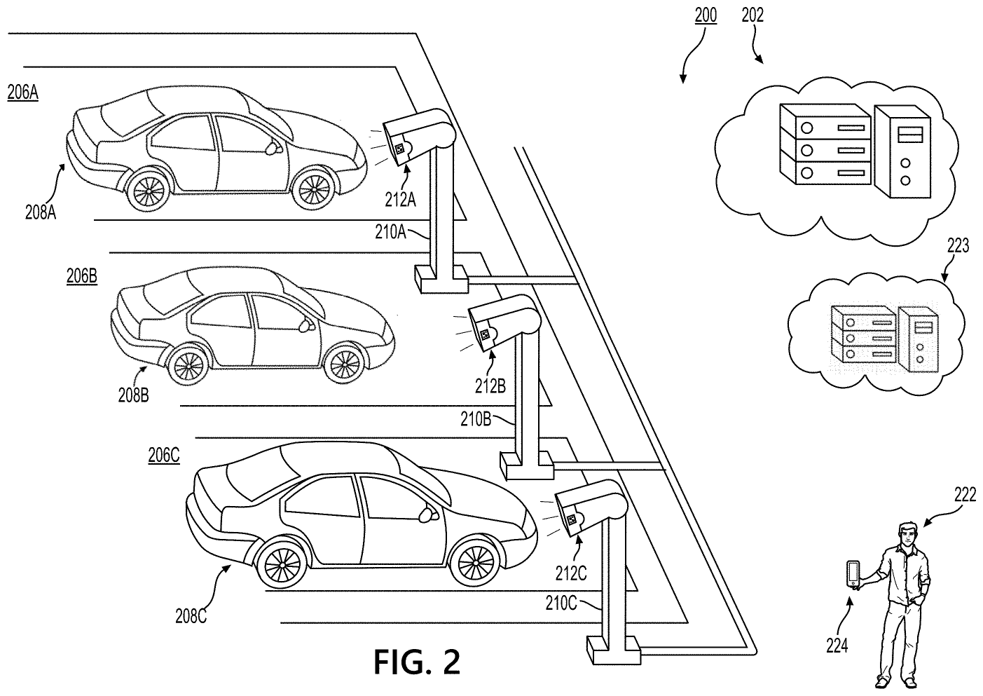

FIG. 2 depicts an example environment such as an auto dealership 200 in accordance with one or more illustrative aspects discussed herein. In at least one aspect, a user 222, via a mobile device 224 (e.g., a smartphone), has accessed a credit server 323 in order to get pre-qualified for a loan amount and/or one or more vehicles located at dealership 200. User 222 may, in some embodiments, request pre-qualification for a particular make and model, or a particular type of vehicle, such as a sedan, a pickup truck, or an SUV, for example. User 222 may also request that they get pre-qualified for one or more vehicles with that have a particular attribute or feature, such as a sunroof, heated seats, or air conditioning, for example.

In certain embodiments, the user 222 may utilize a device other than mobile device 224 to access credit server 323, such as a personal computer, tablet computer, laptop, or the like, which may include at least some of the features described herein. The mobile device 224 may belong to a user seeking to utilize systems and methods described herein, and may be used to send requests to and/or receive notifications from credit server 323, e.g., via an application and/or a program hosted, managed, and/or otherwise controlled by credit server 323. Credit server 323 may be operated by a credit card company, bank, or other financial institution that is in a position to extend credit to user 222. It is to be appreciated that in certain embodiments user 222 may access credit server 323 to get pre-qualified before they arrive at dealership 200, while in other embodiments user 222 may access credit server 323 to get pre-qualified while they are at dealership 200.

Once the user 222 has been pre-qualified by credit server 323, a notification may be sent by credit server 323 to dealer server 202 that user 222 is pre-qualified for one or more vehicles. User 222 may then be authorized by dealer server 202 to unlock and browse one more vehicles at dealership 200 using their mobile device 224 with minimal human interaction. Dealer server 202 may send a digital master key to mobile device 224 of user 222, which will pre-provision mobile device 224, thereby allowing user 222 to unlock but not start one more vehicles at dealership 200.

For example, the user 222 may have been pre-qualified for vehicles 208A-B, but not vehicle 208C. Dealer server 202 may then send a signal to an application running on mobile device 224, which will provide mobile device 224 of user 222 with a digital master key, thereby pre-provisioning mobile device 224 to create a provisioned device. The digital master key on mobile device 224 will then allow user 222 to unlock and browse vehicles 208A-B, but not vehicle 208C. User 222 advantageously may unlock and browse vehicles 208A-B without the need to interact with a salesperson or any other individual at dealership 200. The digital master key on mobile device 224 may be configured to wirelessly transmit unlock and lock instructions to vehicles 208A-B, allowing user 222 to access and browse each of vehicles 208A-B.

In certain embodiments, the digital master key will automatically unlock each of vehicles 208A-B when user 222 with mobile device 224 approaches and is close proximity to the respective vehicles 208A-B. In certain embodiments, the digital master key will unlock each of vehicles 208A-B when user places mobile device 224 in close proximity to a sensor on vehicles 208A-B. In other embodiments, user 222 may activate an application running on mobile device 224 to unlock vehicles 208A-B.

In certain embodiments, the digital master key on mobile device 224 may allow user 222 to limited access to one or more of vehicles 208A-B. That is, the digital master key on mobile device 224 may restrict the access by user 222 to only portions of one or more vehicles at dealership 200. For example, digital master key on mobile device 224 may allow user 222 to unlock the door, glove compartment, and trunk of vehicle 208A, but only unlock the door and trunk, but not the glove compartment, of vehicle 208B. This may allow dealership to protect items locked in the glove compartment of vehicle 208B, for example.

In the illustrated example, for simplicity only three vehicles 208A-C are illustrated, with user 222 being pre-qualified for two of the three vehicles. It is to be appreciated that dealership 200 could have a large number of vehicles, on the order of dozens or more vehicles, with user 222 being pre-qualified for many more than two vehicles. The number of vehicles for which user 222 has been pre-qualified is not intended to be limited by any factors beyond those used during the pre-qualification process.

In certain embodiments, the digital master key on mobile device 224 may be operable for a limited time period. The time period may be determined, for example, on the availability of the user to view vehicles at a particular time. Thus, user 222 may arrange to be at dealership 200 for one or more particular windows of time on one or more particular days. In such a case the digital master key on mobile device 224 may only be active for those particular windows of time.

In other embodiments, dealership 200 may restrict the availability of vehicles for user 222 to view to a certain time period. In certain embodiments, the time period may be dependent on availability of the vehicles for viewing at dealership 200. In such a case, dealership 200 may have a particular window of time in which the vehicles for which user 222 is pre-qualified are available to be viewed, in which case a notification may be sent from dealer server 223 to user 222 informing them of the window of time in which digital master key will be active on mobile device 224 of user 222.

It is to be appreciated that the digital master key on mobile device 224 may be invalidated or voided by dealership 200 at any time. For example, if one or more of vehicles 208A-B for which user 222 has been provided with a digital master key becomes unavailable for viewing (e.g., vehicle 208A has been sold, has been taken out on a test drive, or is being serviced) before user 222 has unlocked the vehicle, a void message may be sent by dealer server 223 to mobile device 224 of user 222, thereby removing the access rights to the unavailable vehicle 208A, but still allowing user 222 access to vehicle 208B. In such an embodiment, dealer server 223 may send a message to mobile device 224, alerting user 222 of the unavailability of vehicle 208A, as well as indicating to user 222 which other vehicles at dealership 200 for which user 222 has been pre-qualified and may unlock and browse. Similarly, when user 222 has completed browsing the vehicles that they are interested in at dealership 200, a void message may be sent by dealer server 223 to mobile device 224 of user 222, thereby removing the access rights to all vehicles for which mobile device 224 has been provided unlocking capability.

In other embodiments, the access rights to unlock the vehicles may be maintained at dealer server 223, and digital master key on mobile device 224 may maintain communication with dealer server 223 while the digital master key is activated. In such an embodiment, dealer server 223 can void access rights to the vehicles at dealer server 223, at which point the digital master key on mobile device 224 would be deactivated.

Dealer server 223 may maintain the availability of access rights for the digital master key on mobile device 224 for a predetermined time, e.g., between 1:00 pm and 3:00 pm on a particular day. In such an embodiment, user 222 would be free to unlock and browse vehicles 208A-B during that time window. At the end of that window of time, dealer server 223 may deactivate the digital master key on mobile device 224.

In order to access the particular vehicles 208A-B they are to browse, user 222 needs to know which specific parking spots vehicles 208A-B are parked in. In some embodiments, a physical marker may be located on the vehicle and/or near a parking space. The physical marker may be stationary (e.g., a sticker having a fixed barcode) or dynamic (e.g., an electronic display, such as an e-ink display, configured to display a barcode). A dynamic physical marker may be updated or changed, e.g., by dealer server 202.

In at least another illustrative aspect, a vehicle 208A may be able to determine the relative location of a parking spot (e.g., parking spot 206A). The vehicle 208A may include an image sensor. For example, an image sensor may be present in an autonomous or semi-autonomous driving system, such as a lane-monitoring system installed on the front of the vehicle. In another example, an image sensor may be a mobile unit installed in the vehicle, such as camera module adhered to a windshield (e.g., a dash cam). In yet another example, an image sensor may be a mobile device, such as a phone, that is tethered to the vehicle. Physical markers 212A-212C may be installed at parking spot systems at, adjacent to, or associated with each parking spot 206A-206C. One or more image sensors may scan, read, or capture data from the physical markers 212A-212C. The image sensors may be located within a vehicle that can be parked in the corresponding parking spot, or may be located within the mobile device 224. In order to allow a vehicle's image sensor to scan, read, or capture data from physical markers 212A-212C with ease, the physical markers 212A-212C may be appropriately positioned to face the vehicle, e.g., via stands 210A-210C. A location sensor (not shown) in the parking spot system may transmit locational information of the parking spot so that the user 222 can be informed of the location of the user's vehicle 208A-B.

In at least another illustrative aspect, a user 222 may be able to locate and obtain directions to the vehicles 208A-B. Dealer server 202 may authenticate user 222 via the user's mobile device 224, and/or may determine that vehicles 208A-B are associated with the user 222 for this visit to dealership 200. Dealer server 202 may obtain the location of vehicles 208A-B, e.g., from a location sensor. Dealer server 202 may then guide user 222 using an augmented reality (AR) application on the user's mobile device 224 to vehicles 208A-B.

Once the user has located vehicle 208A and or 208B, a user 222 may be able to lock or unlock the requested vehicle via the digital master key that has been loaded on the user's mobile device 224.

It is to be appreciated that after viewing a particular vehicle at dealership 200, user 222 may wish to test drive that particular vehicle. In such an embodiment, user 222 could contact a sales representative or other individual at dealership 200, provide necessary identification (e.g., a driver's license) and get authorization to test drive a vehicle. Dealer server 202 could update the digital master key residing on mobile device 224 of user 222 to allow the particular vehicle to be started by user 222 so that they may test drive the vehicle.

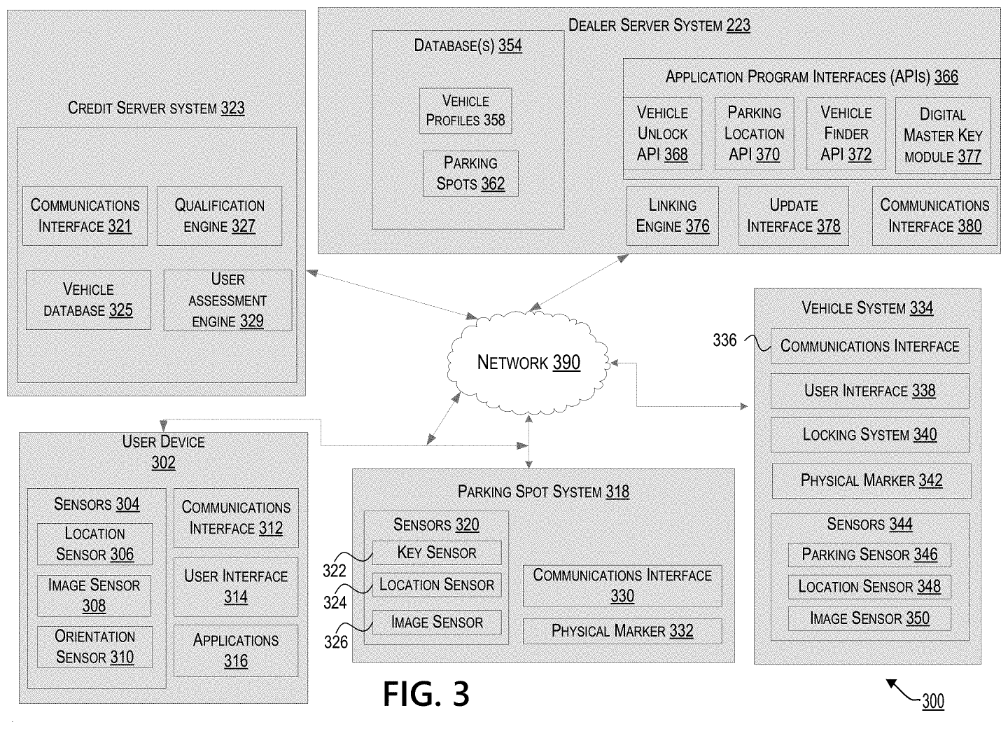

FIG. 3 depicts an example network 300 in accordance with one or more illustrative aspects discussed herein. Each component or subcomponent shown in FIG. 3 may be implemented in hardware, software, or a combination of the two. Additionally, each component or subcomponent may include a computing device (or system) having some or all of the structural components described above for computing device 101. At a high level, the network 300 may include, for example, one or more mobile devices (e.g., mobile device 302), one or more parking spot systems (e.g., parking spot system 318), one or more vehicle systems (e.g., vehicle 334), one or more credit server systems (e.g., credit server 323) and one or more server systems (e.g., dealer server system 223). The mobile device 302 (e.g., a “user device”) may comprise a mobile phone (e.g., smartphone), personal computer, tablet computer, laptop, or the like, which may include at least some of the features described herein. The mobile device 302 may belong to a user seeking to utilize systems and methods described herein, and may be used to send requests to and/or receive notifications from server system 223, e.g., via an application and/or program hosted, managed, and/or otherwise controlled by the server system 223. For example, the mobile device 302 may be used to request access to a smart key storage device, such as smart key storage device 328, to be able to remove a stored vehicle key to test drive a vehicle, such as the vehicle associated with vehicle system 334. The mobile device 302 may be a computing device distinct from the parking spot system 318, or the dealer server system 223.

According to some aspects of the disclosure described herein, the mobile device 302 may comprise one or more components or features described below. Through a communications interface 312, the mobile device may be able to form wired and/or wireless data connections with other computing systems and devices, such as the one or more components of the parking spot system 318, the vehicle 334, and the server system 223, as described further below, via an internet and/or other telecommunications network (e.g., network 390). The mobile device 302 may include various sensors 304 configured to capture physical data (e.g., from physical markers); collect locational, geographical, and/or movement information; and/or transmit data. For example, the mobile device 302 may comprise a built-in or connected image sensor 308 (e.g., a camera, a scanner, etc.) that may scan and/or generate image and/or video data. A user may operate image sensor 308 to capture image and/or video data including a physical marker associated with parking sport system 318 and/or vehicle system 334, for example, a linear barcode, a matrix (2D) barcode (e.g., Aztec Code, augmented reality (AR) code, data matrix, quick response (QR) code, etc.) associated with a device and/or system. The sensors 304 within the mobile device may further include one or more orientation sensors 310 (e.g., gyrometer, solid-state gyroscope, accelerometer, compass, etc.) to measure a measure acceleration, direction, and/or rotation of the vehicle. Furthermore, the sensors 304 may include a location sensor 306 (e.g., global positioning system (GPS)) to determine a location of the mobile device. Other types of sensors may also be downloaded as applications 316. The mobile device 302 may also store user-specific identifying information within its memory (not shown), which can be accessed by or sent to the server 223, e.g., as metadata.

The user interface 314 may be a display coupled with input devices (e.g., keyboard, type pad, touch screen, mouse, buttons, icons, microphone, sensors, etc.) that allows a user to send requests, input information and/or view information. For example, the user interface 314 may allow user 222 to send a request to credit server system 223 requesting pre-qualification for vehicles or vehicle types that user 222 is interested in browsing.

Additionally, user interface 314 may allow user 222 to send a request to the dealer server system 223 regarding browsing vehicles. The user interface 314 may then display instructions to the user regarding the location of the dealership and where the vehicles in question are parked. The mobile device 302 may also run programs or applications 316 on a user interface 314. One application or program may enable a user to use the systems and methods described herein to unlock and browse a vehicle with limited human interaction. The application or program may be provided to the user device or hosted by server 223 (e.g., via an application program interface (API) 366). In some implementations, the mobile device 302 may include one or more subcomponents of computing device 101, shown in FIG. 1.

The parking spot system 318 may include one or more devices, computing systems, or sensors at, adjacent to, or associated with a parking spot of a vehicle. The parking spot system 318 may include one or more of the features and components described below. The parking spot system 318 may include various sensors 320 configured to capture physical data (e.g., from a physical marker on mobile device 302 or on a vehicle parked in a vehicle spot at, adjacent to, or associated with the parking spot system 318); collect locational or geographical information (e.g., via location sensor 324); and/or transmit sensor data. For example, the parking spot system 318 may include a built-in or affixed image sensor 326 (e.g., a camera, a scanner, etc.) that may scan and/or generate image and/or video data. These data may include, for example, a linear barcode, a matrix (2D) barcode (e.g., QR code, AR code, etc.). Thus, a user may present a mobile device with a downloaded or displayed physical marker to the image sensor 326 so that the image sensor can capture or register a requisite image or video data (e.g., linear barcode, matrix barcode, etc.). In some implementations, as a vehicle is being parked into a parking spot at, adjacent to, or otherwise associated with the parking spot system 318, the image sensor 326 may be able to detect a physical marker on the vehicle.

The parking spot system 318 may include a communications interface 330 to establish wireless, wired, or network connections with one or more other systems (e.g., the mobile device 302, the server system 223, the vehicle systems 334, etc.)

The parking spot system 318 may further comprise a physical marker 332. The physical marker 332 may be a linear barcode (e.g., universal product code (UPC)), matrix barcode (e.g., QR code, AR code, etc.), or an RFID tag. The physical marker 332 may be utilized by a scanner, image sensor, and/or reader, e.g., on the mobile device 302 or the vehicle. For example, a user seeking to obtain a vehicle key from the smart key storage device 328 may be instructed to present scan, capture, and/or register the physical marker 332 (e.g., a QR code) using an image sensor 308 of the mobile device 302. The image sensor may be used by an application 316.

The vehicle 334 may include one or more devices, computing systems, circuitry or sensors that are interior to, exterior to, or otherwise associated with a vehicle. The parking spot system 318 may include one or more of the features and components described below, according to some aspects of the present disclosure. For example, the vehicle 334 may include various sensors 334 configured to capture a state of the vehicle (e.g., parking sensor 346); collect locational or geographical information (e.g., location sensor 348); scan, read, or capture image or video (e.g., image sensor 350); and/or transmit sensor data. For example, a parking sensor 346 may detect when a vehicle is being parked or is in a “parked” state. The parking sensor 346 may be an accelerometer that recognizes a vehicle parking based on a change in acceleration of a component of the vehicle (e.g., that the vehicle has ceased movement for a threshold time). Also or alternatively, the parking sensor 346 may be an image sensor reading when an indicator for parking is turned on, or a sensor (e.g., an ODBII-compatible sensor) that detects a change in a mechanical structure of the vehicle (e.g., brakes, clutch, etc.) as the vehicle is parked. The vehicle 334 may include a location sensor (e.g., a global positioning service (GPS)) to capture and present a location of the vehicle. In some implementations, the vehicle 334 may include an image sensor 350 that scans, reads, or captures a physical marker at a parking spot (e.g., physical marker 332 of the parking spot system 318), as the vehicle parks or approaches the parking spot. From data captured from the physical marker 332, the image sensor 350 may allow the server system 223 to determine the locational information of the parking spot. For example, the server system 223 may have a list of known locations associated with identifiers and other data captured by sensors from physical markers. As discussed herein, there may be a physical marker located on one or more of the parking spot system (e.g., physical marker 332), or the vehicle system 334 (e.g., physical marker 342), according to some aspects of the present disclosure.

Additionally, or alternatively, the vehicle may include a physical marker, e.g., physical marker 342, which may comprise a linear barcode, matrix barcode, RFID tag, etc. Thus, in some aspects, a user could rely on an image sensor 326 of the parking spot system 318 to scan a physical marker on the vehicle (e.g., physical marker 342), rather than use the mobile device's image sensor 308 to scan a physical marker 332 of the parking spot system 318. Thus, the parking spot system 318 may comprise an image sensor 326 that may scan the physical marker 342 to determine if/where the vehicle 334 is parked. This may be an alternative to the vehicle 334 recording the physical marker 332. The physical marker may be stationary (e.g., a sticker having a fixed barcode) or dynamic (e.g., an electronic display configured to display a barcode). For example, a dynamic physical marker may be updated or changed by the vehicle 334 and/or by one or more external systems (e.g., mobile device 302, parking spot system 318, server system 223, etc.). In some implementations, a sensor 320 from the parking spot system 318 (e.g., image sensor 326) or a sensor 304 from the mobile device 302 may scan, read, and/or capture data from physical marker 342.

The vehicle 334 may also include a user interface to allow user 222 to view sensor data (e.g., location, vehicle state, parking spot information, etc.) received from the above-described sensors, or communicate with external systems. The vehicle 334 may send information to or receive information from other systems (e.g., the mobile device 302, the parking spot system 318, the server system 223, etc.) over a network 390, via communications interface 336. The communications interface 336 may comprise a wireless communications interface, such as a cellular connection (e.g., LTE, 5G), a Wi-Fi connection (e.g., Wi-Fi 5 or Wi-Fi 6), or a Bluetooth tether to a mobile device 302.

The server system 223 may comprise one or more remote, local, and/or connected computing systems or servers managing one or more functions of the above-described systems (e.g., the mobile device 302, the parking spot system 318, the vehicle 334, etc.) to facilitate methods and systems described herein. For example, in some implementations, server 223 may be connected to the parking spot system 318. At a high level, the server system may comprise one or more databases 354, application program interfaces (APIs) 366, a linking engine 376, an update interface 378, and a communications interface 380. The update interface 378 and linking engine 376 may form a database management application, software, or plug-in that may be used to perform create, read, update, or destroy (CRUD) functions with respect to data stored in the one or more databases 354. For example, the linking engine 376 may be used to form associations or link suitable data from different databases together, and/or to create new data based on associations or linkages. The update interface 378 may be used to update databases (e.g., by adding or deleting) data stored in the one or more databases 354 based on instructions from other parts of the server system 223 (e.g., computer readable instructions stored in memory of an API) or information received from one or more external systems (e.g., the mobile device 302, the parking spot system 318, the vehicle 334, etc.). The server system 223 may send information to or receive information from the external systems over a network 390 via communications interface 336.

Dealer server system 223 may include one or more databases described below. For example, the sever system 223 may include a database of known parking spots 362, e.g., based on a geographic region. For example, the database of parking spots 362 may store identifiers of parking spots within a predetermined distance from a designated address or location. The address or location may be based on the location of a user, which can be found using a location sensor, e.g., of the mobile device 302 or of the vehicle system 334. Thus, a database of parking spots 362 for the example environment illustrated in FIG. 2 may include identifiers of parking spots 206A-206C.

Also or additionally, sever system 223 may include a database of vehicle profiles 358. The vehicle profiles may identify vehicles, e.g., by vehicle identification numbers, license plate numbers, and/or or other vehicle descriptors. In some examples, a vehicle may be identified based on an identifier of its vehicle key (e.g., a vehicle key ID). The list of vehicles may depend on the systems and methods for which the server 223 is being utilized. For example, the vehicle profiles database 358 may identify vehicles that one or more users may unlock and browse with limited human interaction based on systems and methods described herein.

The server system 223 may include one or more APIs described below. The server system 223 may include, e.g., an API for an application for unlocking vehicles using a mobile device (e.g., vehicle unlock API 368), an API for an application for tracking a parking location using a parking sensor (e.g., parking location API 370), and/or an API for an application for finding a vehicle using a mobile device (e.g., vehicle finder API 372).

Credit server 323 may comprise one or more remote, local, and/or connected computing systems or servers managing one or more functions of the above-described systems (e.g., a qualification engine 327, a user assessment engine 329, etc.) to facilitate methods and systems described herein. For example, in some implementations, credit server 223 may be connected to the dealer server system 223 and user device 302. At a high level, the server system may comprise a vehicle database 325 of vehicles available at auto dealerships, and a communications interface 321. Credit server 323 may send information to or receive information from the external systems over a network 390 via communications interface 321.

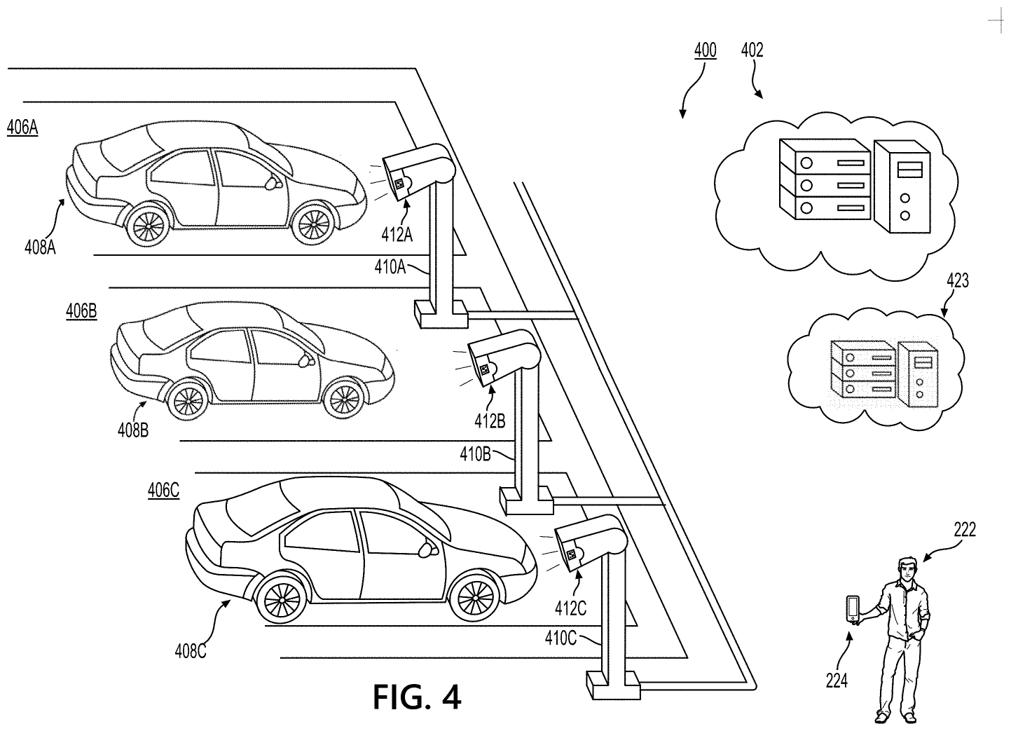

FIG. 4 illustrates a second auto dealership 400 with a corresponding dealer server 402 and an inventory of vehicles 404A-C in parking spots 406A-C. It is to be appreciated that the actual number of vehicles at dealership 400 may be much larger than the three vehicles 404A-C that are shown here for illustrative purposes. After unlocking and browsing one or more of vehicles 208A-C at dealership 200, user 222 may request to view vehicles at another dealership. User 222 may contact credit server 323 and request that they be provided with other vehicles for which they are pre-qualified at one or more additional dealerships. User 222 may then subsequently be notified of vehicles for which they are pre-qualified that are located at second dealership 400. In certain embodiments, user 222 may be notified of other vehicles for which they are pre-qualified without requesting such a list. In a manner similar to that described above, dealer server 423 may provide a digital master key to the mobile device 224 of user 222 to allow user 222 to unlock and browse one or more of vehicles 404A-C of the inventory at second dealership 400.

In certain embodiments, based on the amount of time user 222 spent browsing a particular vehicle at dealership 200, a recommendation may be provided to user 222 regarding additional vehicles that user 222 might be interested in, and which are within a particular geographical area that is convenient for user 222 to visit. Thus, for example, credit server 323 could pre-qualify user 222 for one or more of the vehicles 408A-C at second dealership 400, and send a notification to user 222 informing them of the availability of vehicles at second dealership 400 for which they are pre-qualified and may be interested in. Credit server 323 could then send a notification to second dealer server 404 forwarding the name of user 222 and indicating the particular vehicles of the inventory of vehicles at second dealership 400 for which user 222 is pre-qualified. Dealer server 402 could then provide a digital master key to mobile device 224 of user 222 for each of the vehicles for which user 222 is pre-qualified, thereby allowing user 222 to unlock and browse these additional vehicles.

It is to be appreciated that user 222 may also be directed to more dealerships beyond dealership 200 and second dealership 400 where user 222 may unlock and browse additional vehicles. The number of dealerships that user 222 may visit after being pre-qualified is not intended to be limited.

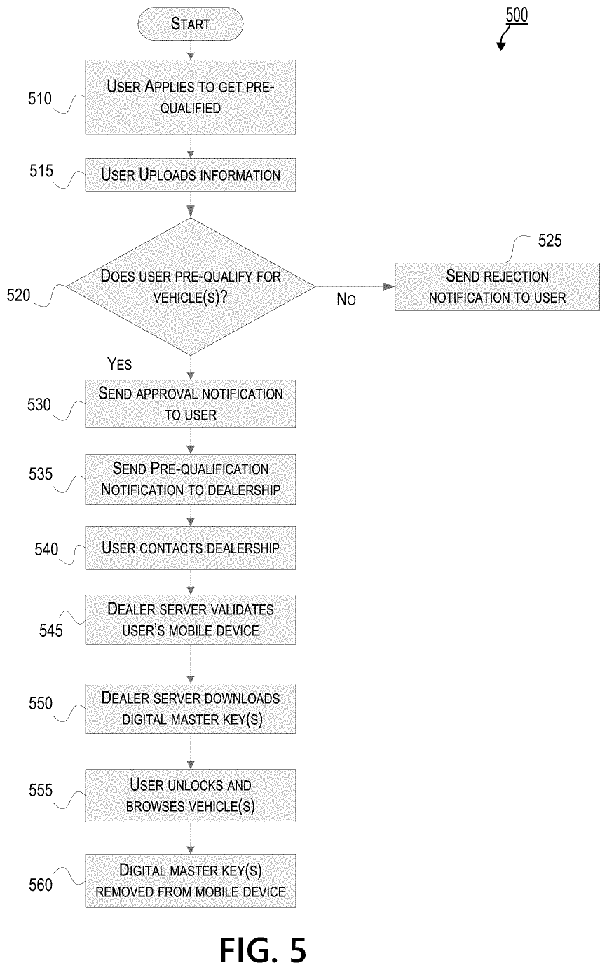

A method 500 of providing a user with access to one or more vehicles at an auto dealership is illustrated in FIG. 5. At step 510, user 222 applies to be pre-qualified for one or more vehicles. At step 515, user 222 uploads information to credit server 323. The information uploaded by user 222 could include identifying and qualification information, vehicle information, and geographical information. The identifying and qualification information could include, for example, the user's name, address, work history, and salary information. The vehicle information could include the type of vehicle or vehicles the user is interested in, and particular vehicle features the user is interested in. The geographical information could include a geographic threshold, i.e., the maximum distance the user would be willing to travel to visit an auto dealership. At step 520, credit server 323 determines if user 222 can be pre-qualified for one or more vehicles using qualification engine 327, which may review the information provided by user 222 to determine which, if any, vehicles user 222 may be pre-qualified for. In certain embodiments, the determination of whether user 222 can be pre-qualified may consist of a soft credit check that does not affect the user's credit score. In other embodiments, the pre-qualification review may be a more thorough evaluation of the user's suitability for credit.

If at step 520, user 222 is not pre-qualified for any vehicles a notification is sent at step 525 by credit server 323 to user 222 informing them that they have not been pre-qualified for any vehicles. If at step 520, user 222 is pre-qualified for one or more vehicles, a notification may be sent at step 530 by credit server 323 to user 222 informing them that they have been pre-qualified, and also providing user 222 with the location at which the vehicle(s) for which they have been pre-qualified are located and which is within the user's geographic threshold if one has been created.

At step 535, credit server 323 may send a notification to dealer server 202 that user 222 have been pre-qualified for one or more vehicles at dealership 200. In certain embodiments the notification being sent by credit server 323 to dealer server 202 at step 535 includes only the name of user 222 and the list of vehicles for which they are pre-qualified. In such an embodiment, personal information such as the user's salary information, for example, is not forwarded to dealer server 223 by credit server 323.

At step 540, user 222 may contact dealership 200 to let them know when user 222 would like to arrange to browse the vehicle(s) for which they have been pre-qualified. At step 545, dealer server 202 confirms that mobile device 224 is the mobile device of user 222 and validates mobile device 224. At step 550, dealer server 202 may upload the digital master key to mobile device 224 of user 222 for each vehicle for which user 222 has been pre-qualified. At step 555, user 222 may unlock and browse each of the vehicles for which they have been pre-qualified. At step 560, after user 222 has finished browsing the vehicles, dealer server 202 may void or otherwise remove the digital master key from the mobile device 224 of user 222.

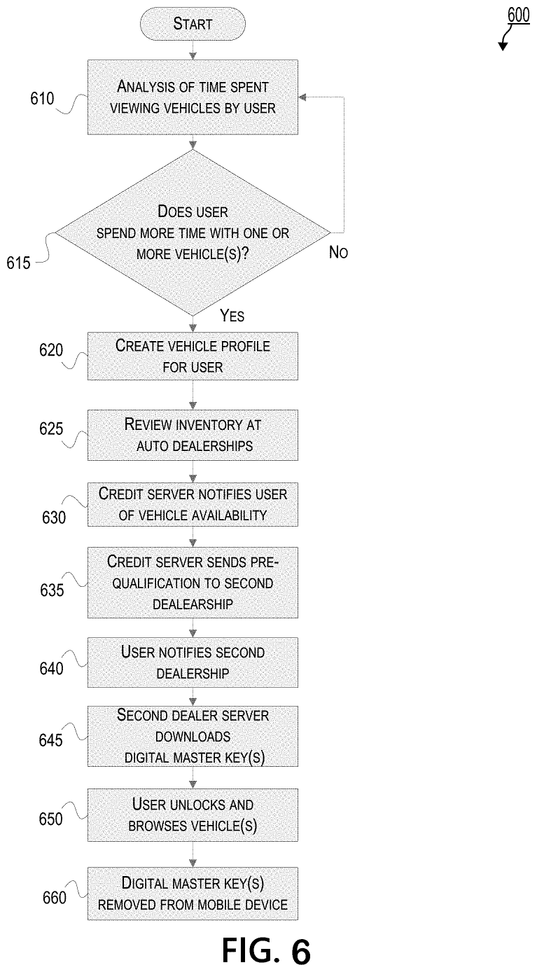

A method 600 of providing a user with access to one or more vehicles at a second auto dealership 400 is illustrated in FIG. 6. Based on the amount of time user 222 spent browsing a particular vehicle at dealership 200, a recommendation may be provided to user 222 regarding additional vehicles that user 222 might be interested in, and which are within a particular geographical area that is convenient for user 222 to visit. Credit server 323 may be linked to the digital master key or another application on mobile device 224 of user 222, which may allow credit server 323 to track the amount of time that user 222 spends viewing one or more vehicles at dealership 200. At step 610, credit server 323 analyzes the time user 222 spends viewing vehicles at dealership 200 using user assessment engine 329, which may calculate the amount of time that mobile device 224 is in proximity of a particular vehicle and compares that time to the amount of time that mobile device 224 is in proximity of other vehicles. At step 615, with user assessment engine 329, credit server 323 determines whether user 222 spends significantly more time viewing one or more vehicles compared to other vehicles, or one or more types of vehicles compared to other types of vehicles. If it is determined at step 615 that user 222 did not spend significantly more time viewing a particular vehicle, or type of vehicle, credit server 323 may continue at step 610 to analyze the time spent by user 222 viewing vehicles. If it is determined at step 615 that user 222 has spent significantly more time viewing a particular vehicle, or type of vehicle, at step 620 credit server 323 may create a vehicle profile for user 222 that includes a type of vehicle that user 222 appears to be most interested in and for which user 222 has pre-qualified. The vehicle profile may also include vehicle features that user 222 appears to be most interested in.

At step 625, credit server 323 may access and review vehicle database 325, which may list the inventory of vehicles at various auto dealerships, such as second dealership 400, with which credit server 323 has established a communication link. By reviewing vehicle database 325, credit server 323 may determine the availability of vehicles that match the vehicle profile for user 222. At step 630, credit server may notify user 222 of the availability of other vehicles at other dealerships, like second dealership 400, that are within the geographical threshold of user 222. At step 635, credit server 323 may send a notification to dealer server 402 of second dealership 400 that user 222 has been pre-qualified for one or more vehicles at dealership 400. In certain embodiments, the notification being sent by credit server 323 to dealer server 402 at step 635 includes only the name of user 222 and the list of vehicles for which they are pre-qualified. In such an embodiment, personal information such as the user's salary information, for example, is not forwarded to dealer server 402 by credit server 323.

At step 640, user 222 may contact second dealership 400 to let them know when user 222 would like to arrange to browse the vehicle(s) for which they have been pre-qualified. At step 645, dealer server 402 may confirm that mobile device 224 is the mobile device of user 222, validate mobile device 224, and download the digital master key to mobile device 224 of user 222 for each vehicle for which user 222 has been pre-qualified. At step 650, user 222 may unlock and browse each of the vehicles at second dealership 400 for which they have been pre-qualified. At step 660, after user 222 has finished browsing the vehicles, dealer server 402 may void or otherwise remove the digital master key from the mobile device 224 of user 222.

One or more aspects described herein may provide automated systems for allowing users to unlock and browse vehicles with limited human interaction. This may have the benefit of reducing the manpower needed to store, sell, lease, or rent vehicles, while reducing the strain on the consumer. For example, a consumer may unlock and access one or more vehicles using a mobile application, which may have the advantage of allowing a user to avoid a pushy salesperson (which may also reduce overhead for a car dealer). This may promote more efficient sales due to reduced friction for the consumer and reduced costs for the retailer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method comprising:
receiving, by a credit entity capable of extending credit to a customer, from a user device, customer information corresponding to the customer, the customer information including at least identity information;
determining, by the credit entity based on the customer information, a first set of vehicles for which the customer has been pre-qualified to finance, the first set of vehicles comprising at least one vehicle of a first model;
receiving dealership information from a plurality of vehicle dealerships, the dealership information comprising an inventory of the respective vehicle dealership, wherein a first vehicle dealership has a corresponding inventory comprising a plurality of vehicles including a first vehicle matching the first model;
forwarding, from the credit entity to the first dealership, a notification that the customer is pre-qualified for the first vehicle,
determining that the first vehicle dealership is within a geographic threshold of the customer;
capturing, by the first vehicle, data from a physical marker associated with a parking spot where the first vehicle is parked;
forwarding, to the customer, location information regarding the parking spot;
validating, with at least a portion of the identity information, a user device of the customer to establish a validated user device; and
pre-provisioning the validated user device with a digital master key to create a provisioned user device configured to provide the user device with access rights to the first vehicle.

2. The computer-implemented method of claim 1, wherein the digital master key is configured to provide the user device with the access rights during a specified time frame.

3. The computer-implemented method of claim 2, wherein the specified time frame is determined from one or more factors, the factors including at least one of: electronic data within the dealership information, electronic availability data of the customer, anticipated availability of one or more vehicles of the corresponding inventory, a selection of the customer, and a selection by the first vehicle dealership.

4. The computer-implemented method of claim 2, further comprising:
prior to the specified time frame, transmitting a void message to the provisioned user device configured to void the digital master key, thereby removing the access rights.

5. The computer-implemented method of claim 1, wherein the provisioned user device is configured to wirelessly transmit an unlock instruction and a lock instruction to each vehicle of the corresponding inventory of the first vehicle dealership.

6. The computer-implemented method of claim 1, wherein the provisioned user device is configured to wirelessly transmit a start engine command to at least one vehicle of the corresponding inventory.

7. The computer-implemented method of claim 1, wherein the provisioned user device is configured to unlock but not start each vehicle of the corresponding inventory of the first vehicle dealership.

8. The computer-implemented method of claim 1, wherein the access rights include access to a first compartment and a second compartment of a first vehicle of the corresponding inventory and a first compartment but not a second compartment of a second vehicle of the corresponding inventory.

9. The computer-implemented method of claim 1, wherein the corresponding inventory of the first vehicle dealership comprises a second vehicle of a second model.

10. The computer-implemented method of claim 9, wherein the first vehicle and the second vehicle of the corresponding inventory each have a first common feature, wherein the first common feature is an automobile attribute that was determined based on a request of the user.

11. The computer-implemented method of claim 1, further comprising:
obtaining access right information indicative of the provisioned user device being utilized to provide the customer with access rights to at least a portion of the plurality of vehicles of the corresponding inventory of the first vehicle dealership;
determining, based on the access right information, a vehicular feature of interest to the customer; and
re-provisioning the provisioned user device with a second digital master key configured to provide the user device with access rights to each vehicle within a corresponding inventory of a second vehicle dealership.

12. A computing device, comprising:
at least one processor;
and
a non-transitory computer-readable medium comprising computer-executable instructions that when executed by the at least one processor, cause the computing device to:
generate a master key specific to a corresponding inventory of a dealership;
determine a plurality of vehicular assets for which a user has been qualified to finance
receive, by a credit entity capable of extending credit to a customer from a remote user device, customer information of the customer including at least customer identity information;
determine by the credit entity a first set of vehicles for which the first customer meets a threshold likelihood to qualify for financing, the first set of vehicles comprising at least one vehicle of a first model, and wherein determining the first set of vehicles is based on the customer information of the first customer and qualification factors;
receive dealership information from a plurality of vehicle dealerships, the dealership information comprising an inventory of the respective vehicle dealership, wherein a first vehicle dealership has a corresponding inventory comprising a plurality of vehicles including a first vehicle matching the first model;
determine that the first vehicle dealership is within a geographic threshold of the customer;
capture, by the first vehicle, data from a physical marker associated with a parking spot where the first vehicle is parked;
forward, to the customer, location information regarding the parking spot;
forward, from the credit entity to the first dealership, a notification that the customer is pre-qualified for the first vehicle;
validate, using at least a portion of the identity information, a user device of the customer to establish a validated user device;
generate a digital master key specific to the corresponding inventory of the first vehicle dealership; and
pre-provision the validated user device with the generated digital master key to create a provisioned user device configured to provide the user with access rights to each vehicle within the corresponding inventory of the first vehicle dealership.

13. The computing device of claim 12, wherein the digital master key provides the user with the access rights during a specified time frame.

14. The computing device of claim 13, wherein the digital master key is a first digital master key, and wherein the computer-readable medium further comprises computer-executable instructions that when executed by the processor, cause the computing device to at least:
receive an electronic signal comprising access right information from the provisioned user device, the access right information including access data obtained during the specified time frame;
based on the access right information, determine a vehicular feature of interest to the customer; and
transmit a re-provisioning signal configured to re-provision the provisioned user device with a second digital master key, the second digital master key configured to provide the user with access rights to each vehicle within a corresponding inventory of a second vehicle dealership.

15. The computing device of claim 14, wherein the corresponding inventory of the second vehicle dealership is devoid of any vehicles of the inventory of the first vehicle dealership.

16. The computing device of claim 14, wherein the computer-readable medium further comprises computer-executable instructions that when executed by the processor, cause the computing device to at least:
transmit a void signal configured to void the first digital master key, such that the provisioned user device is configured to utilize the second digital master key but cannot utilize the first digital master key.

17. The computing device of claim 13, wherein the specified time frame is determined from one or more factors, the factors including at least one of: electronic data within the dealership information, electronic availability data of the customer, anticipated availability of one or more vehicles of the corresponding inventory, a selection of the customer, and a selection by the dealership.

18. The computing device of claim 13, further comprising:
prior to the specified time frame, transmitting a void message to the provisioned user device configured to void the digital master key, thereby removing at least a portion of the access rights.

19-20. (canceled)
